(19) United States
(12) Patent Application Publication
(10) Pub. No.: US 2015/0312351 A1
(43) Pub. Date: Oct. 29, 2015

(54) METHOD, DEVICE AND SYSTEM FOR DEVICE TRIGGER IN IOT

(71) Applicants: Zhi Wang, Shanghai (CN); Yigang Cai, Naperville, IL (US)

(72) Inventors: Zhi Wang, Shanghai (CN); Yigang Cai, Naperville, IL (US)

(73) Assignee: ALCATEL LUCENT, Boulogne Billancourt (FR)

(21) Appl. No.: 14/692,914

(22) Filed: Apr. 22, 2015

(30) Foreign Application Priority Data
Apr. 24, 2014 (CN) 201410169198.6

(51) Int. Cl. H04L 29/08

(52) U.S. Cl. CPC H04L 67/125

(57) ABSTRACT

An object of the invention is providing a method, device and system for Device Trigger in IoT. The network device obtains device trigger request(s) corresponding to one or more target devices, and determines, based on the device trigger request in conjunction with subscribed data corresponding to the target device, a device trigger response corresponding to the device trigger request. Compared with the prior art, the present invention provides a proxy mechanism used in IoT/MTC, i.e., with the network device as a proxy for the target device, a device trigger request corresponding to the target device is processed to reduce unnecessary trigger request to the target device, and reduce resource/energy (such as CPU, memory, network connection, etc. . . . ) consumption for the IoT/MTC devices and network; furthermore, the present invention would further reduce the response time of device trigger and improve the quality of services in IoT.

### FIELD OF THE INVENTION

The present invention relates to the field of IoT, and in particular to the technology of Device Trigger in IoT.

### BACKGROUND OF THE INVENTION

Internet of things (IoT) will exponentially increase the scale and the complexity of existing computing and communication systems. As a new paradigm, Internet of things, also known as Machine-Type communications (MTC) or Machine-to-communications (M2M), where smart computing devices that collect data, relay information to one another, process the information collaboratively, and take action automatically, is offering both challenges and opportunities.

Since most of smart computing devices deployed within the Internet of Things are expected to be resource constrained, one key challenge in IoT is resource/energy saving. How to save the resource/energy in constrained smart devices (e.g. all kinds of sensors, etc. . . . ), networks (e.g. low power wireless personal area networks, etc. . . . ) are raised.

3GPP TS 23.682 provides the 3GPP Architecture for Machine-Type Communications (similarly, M2M architecture provided by ETSI, Constrained RESTful Environments (CoRE) provided by IETF, etc. . . . match 3GPP Architecture mostly). However, so much device trigger requests from different client or Application Server (AS) may add a heavy burden on the MTC devices which would consume much of resource/energy of it. Moreover, it would also introduce heavy burden on the network. All this would further be exacerbated by the deterioration of services, e.g. delay of device trigger response, network congestion, etc. . . . . So, a solution is critical necessary to optimize existing architecture and protocols to reduce resource/energy consumption at constrained MTC devices and network.

### SUMMARY OF THE INVENTION

An object of the invention is providing a method, device and system for Device Trigger in IoT.

According to one aspect of the invention, a method for device trigger in IoT by a network device is provided, wherein the method comprises:

a. obtaining device trigger request(s) corresponding to one or more target devices;

b. determining, based on the device trigger request in conjunction with subscribed data corresponding to the target device, a device trigger response corresponding to the device trigger request.

According to another aspect of the invention, a method for device trigger in IoT subsidiarily by a target device is further provided, wherein the method comprises:

A. obtaining a data subscription request sent by a network device;

B. providing subscribed data corresponding to the data subscription request to the network device based on the data subscription request.

According to another aspect of the invention, a network device for device trigger in IoT is further provided, wherein the device comprises:

request obtaining module configured to obtain device trigger request(s) corresponding to one or more target devices;

response determining module configured to determine, based on the device trigger request in conjunction with subscribed data corresponding to the target device, a device trigger response corresponding to the device trigger request.

According to another aspect of the invention, a target device for device trigger in IoT subsidiarily is further provided, wherein the device comprises:

subscription obtaining module configured to obtain a data subscription request sent by a network device;

data providing module configured to provide subscribed data corresponding to the data subscription request to the network device based on the data subscription request.

According to another aspect of the invention, a system for device trigger in IoT is further provided, wherein the system comprises the network device as aforesaid, and the target device as aforesaid.

Compared with the prior art, the present invention obtains device trigger request(s) corresponding to one or more target devices by a network device, and determines, based on the device trigger request in conjunction with subscribed data corresponding to the target device, a device trigger response corresponding to the device trigger request. It provides a proxy mechanism used in IoT/MTC, i.e., with the network device as a proxy for the target device, a device trigger request corresponding to the target device is processed to reduce unnecessary trigger request to the target device, and reduce resource/energy (such as CPU, memory, network connection, etc. . . . ) consumption for the IoT/MTC devices and network. Furthermore, the present invention would further reduce the response time of device trigger and improve the quality of services in IoT.

### BRIEF DESCRIPTION OF THE DRAWINGS

Other features, purposes and advantages of the invention will become more explicit by means of reading the detailed statement of the non-restrictive embodiments made with reference to the accompanying drawings.

FIG. 1 shows an architecture diagram of a system for MTC device trigger as proposed in the 3GPP TS23.682 Specification;

FIG. 2 shows a schematic diagram of a network device for device trigger in IoT according to one aspect of the present invention;

FIG. 3 shows a schematic diagram of a network device and a target device for device trigger in IoT according to one preferred embodiment of the present invention;

FIG. 4 shows a flow diagram of a method for device trigger in IoT by a network device according to another aspect of the present invention;

FIG. 5 shows a flow diagram of a method for device trigger in IoT by cooperation of a network device and a target device according to one preferred embodiment of the present invention;

FIG. 6 shows a data subscription flow diagram improved based on the 3GPP TS29.36 Specification according to a preferred embodiment of the present invention;

FIG. 7 shows a flow diagram of device trigger in IoT improved based on 3GPP TS23.682 Specification according to one preferred embodiment of the present invention.

FIG. 8 shows a functional architecture diagram of realizing device trigger in IoT by cooperation of a network device and other devices according to one preferred embodiment of the present invention.

The same or similar reference signs in the drawings represent the same or similar component parts.

### DETAILED DESCRIPTION OF THE INVENTION

Below, details of the invention will be further provided in combination with the accompanying drawings.

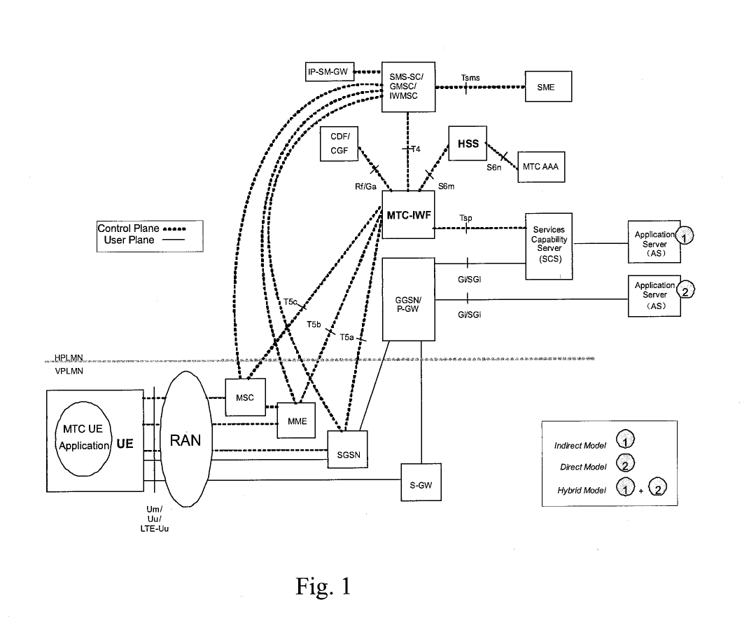

FIG. 1 shows an architecture diagram of a system for MTC device trigger as proposed in the 3GPP TS23.682 Specification. The present invention may be deployed in the system architecture as shown in FIG. 1 so as to meet the requirements in TS22.368 of the IoT/MTC and the requirements in TS23.682 of MTC architecture, at the same time, realize optimization of the existing IoT/MTC procedure and function, thereby realizing the method of Device Trigger in IoT as proposed in the present invention.

Specifically, the network device or the function corresponding to the network device is deployed on any one or more devices such as MTC-IWF (MTC-Inter Working Function), SMS-SC (Short Message Service-Service Center), SCS (Services Capability Server), AS (Application Server) and so on. For the convenience of depiction, illustration will be made with MTC-IWF enhancement as an example. Here, those skilled in the art should understand that other device enhancements are also applicable to the present invention and covered within the protection scope of the present invention.

Besides, by enhancing the UE to cooperate with the network device, the mechanism of device trigger in IoT according to the present invention is realized. When the data subscribed by MTC-IWF changes, the MTC UE application may update the data to MTC-IWF. The MTC-IWF may maintain the subscription using the local database or temporarily maintain the subscription using a centralized database (e.g., HSS (Home Subscriber Server)).

Here, those skilled in the art should understand that FIG. 1 only illustrates a preferred embodiment of applying the present invention to system architecture for MTC device trigger as proposed in the 3GPP TS23.682 Specification, rather than limiting the present invention. Other IoT/MTC architecture than 3GPP architecture, for example, ETSI M2M architecture for MTC communication, IETF CoRE architecture, are likewise applicable to the present invention and covered within the protection scope of the present invention.

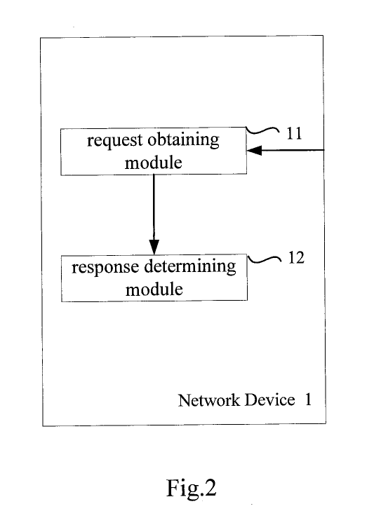

FIG. 2 shows a schematic diagram of a network device for device trigger in IoT according to one aspect of the present invention; wherein, the network device comprises: a request obtaining module 11, a response determining module 12. Specifically, the request obtaining module 11 obtains device trigger request(s) corresponding to one or more target devices; the response determining module 12 determines, based on the device trigger request in conjunction with subscribed data corresponding to the target device, a device trigger response corresponding to the device trigger request.

Here, the network device includes, but not limited to, independent network device(s), or integrated device(s) of the network device and other device through the network or hardware. Wherein, the network device includes an electronic hardware device or software device that automatically perform numerical value computation and information processing according to a pre-set or pre-stored instruction; wherein the hardware device includes, but not limited to, a microprocessor, an application-specific integrated circuit (ASIC), a field programmable gate array (FPGA), a digital processor (DSP), an embedded device, etc. The network device includes, but not limited to, personal computer(s), network host(s), single network server, a set of multiple network servers or a cloud network formed by multiple servers; herein, the cloud network is formed by a large number of computers or network servers based on Cloud Computing, wherein, the cloud computing is a kind of distributed computing, which is a virtual supercomputer consisting of a group of loosely coupled computers set. The said other device is any one or more devices in IoT/MTC such as MTC-IWF (MTC-Inter Working Function), SMS-SC(Short Message Service-Service Center), SCS(Services Capability Server), AS (Application Server), and so on.

The target device includes, but not limited to any one of terminal devices for device trigger in the IoT/MTC, e.g., user equipment, sensor device, etc.

Those skilled in the art should understand that other network devices and/or target devices, if applicable to the present invention, should also be included within the protection scope of the present invention and are incorporated here by reference.

The above modules work constantly therebetween. Here, those skilled in the art should understand that “constantly” means the above various modules perform obtaining device trigger request(s), determining a device trigger response respectively in real-time or according a preset or real-time adjusted working pattern requirements, until the network device stops obtaining device trigger request(s) corresponding to one or more target devices.

The request obtaining module 11 obtains device trigger request(s) corresponding to one or more target devices.

Specifically, the request obtaining module 11 may obtain, through various kinds of relevant protocols, device trigger request(s) for one or more target devices from other device or application. Here, if the device trigger request corresponds to a single target device, then the device trigger request contains device identification information of the target device; if the device trigger request(s) corresponds to a plurality of target devices, then the device trigger request contains device identification information of a plurality of the target devices. Preferably, device trigger may be further applied to a device group, and then the device trigger request includes identification information of the group. A plurality of device addresses corresponding to the group identification information is obtained by for example MTC-IWF, SMS-SC or MME from the local database or centralized database (e.g., HSS).

The response determining module 12 determines, based on the device trigger request in conjunction with subscribed data corresponding to the target device, a device trigger response corresponding to the device trigger request.

Specifically, the response determining module 12 obtains the subscribed data by obtaining stored subscribed data corresponding to the target device from the local database, or obtains the subscribed data from the centralized database (e.g., HSS), wherein the subscribed data includes, but not limited to, the data corresponding to applications of the target device, presence information of the target device, various kinds of predetermined processing logic corresponding to the target device, and etc.; then, the response determining module 12 detects, with reference to the subscribed data, the device trigger request to determine whether it should respond directly, reject to respond, or forward the trigger request to other device.

Herein, the device trigger response includes at least one of the following:
Responding the device trigger request, i.e., the network device responds directly based on the subscribed data on behalf of the target device; in the case of responding directly, the device trigger request will not be sent the corresponding target device. Preferably, to make it's transparent to the request originator; the network device may also generate the delivery report before sending real trigger response if needed.
Rejecting the device trigger request, for example, based on the subscribed data, when the target device is not available (e.g. offline, busy, low battery, or outside defined available time intervals, or it's not in the location that predefined, or other scenarios that matches the definition of target device unavailable . . . ), it will reject by sending normal Message Delivery Report (including such as cause code, trigger reference number, SCS Identifier) to the request originator.
Routing the device trigger request, i.e., routing the device trigger request to related device; for example, if the above 2 actions cannot be taken, the network device will determine to route the device trigger request to such as the target device requested or alternative device; for example, if the target device is not available (e.g. offline, busy, low battery, or outside defined available time intervals), or the target device has been presented, or the network device has received notification from the target device, then the trigger request will be forwarded to alternative device. Here, preferably, to make all this operations transparent to the target device or requested device, the target device may modify related parameters in the device trigger response, such as, modification the origination address of the device trigger response to the target device requested.

Preferably, the response determining module 12 determines, based on the device trigger request in conjunction with subscribed data corresponding to the target device and related configuration strategy, a device trigger response corresponding to the device trigger request.

Specifically, the related configuration strategy includes, but not limited to, device trigger handling logic, time controlled logic, presence controlled logic, routing logic and data subscription logic and so on.

Here, once the network device receives a device trigger request, the device trigger handling logic will be started; specifically, the network device queries, from among the local or global database (e.g., HSS) a trigger request handling policy for the target device, and further, may also determines whether to call ancillary policies such as time controlled logic, presence controlled logic, and the like; if the trigger request should not be rejected, detects the data as requested by the trigger request have been subscribed or not; if so, directly responds to the source device with the subscribed data; if a route is needed, the routing logic will be called to perform routing.

The time controlled logic allows sending the device trigger request(s) to the target device only during defined time intervals and avoid unnecessary trigger delivery outside these defined time intervals. Specifically, the time controlled logic queries the time control policy from local or global database (e.g., HSS) for the target device; and takes action base on the policy and local time of the network device/target device.

The presence controlled logic allows customizing the trigger request handling base on the presence of the target device, e.g., online, offline, busy, low battery, location, etc. . . . . Specifically, the presence controlled logic queries the presence control policy from local or global database (e.g., HSS) for the target device; and takes action base on the policy and saved presence data of the target device. Herein, if presence controlled logic is enabled on the network device, presence information can be retrieved from the subscribed data, or alternatively, the presence information can also be retrieved by querying other network devices, like HSS, etc. . . . .

The routing logic will determine whether route the trigger request to target device it requested or other devices or not. Specifically, the routing logic queries the routing control policy from local or global database (e.g. HSS) for the target device, and applies the routing logic base on the policy. At least, one of below 2 routing will be taken:
Route to the required target device;
Route to alternative target device; this happens in the scenario of load balance, required target device unavailable, or other scenarios that matches the definition for alternative routing.

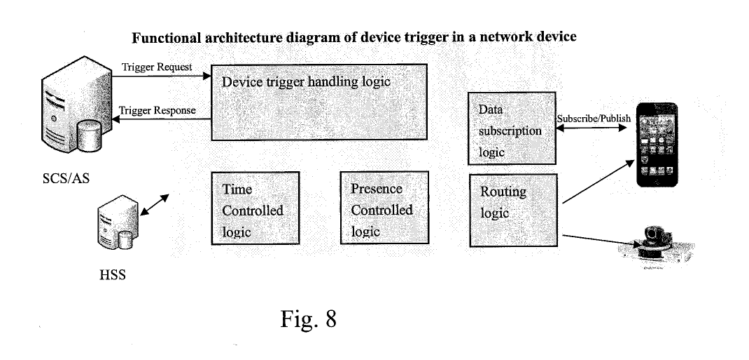

FIG. 8 shows a functional architecture diagram of realizing device trigger in IoT by cooperation of a network device and other devices according to one preferred embodiment of the present invention. Here, SCS/AS sends a device trigger request to a target device (e.g., mobile phone or camera); the network device in conjunction with HSS, responds to the device trigger request based on the device trigger handling logic, time controlled logic, presence controlled logic, routing logic and data subscription logic and so on; the data subscription logic performs data subscription and publication and the like to the target device.

Here, those skilled in the art should understand, FIG. 8 only illustrates a functional architecture diagram of realizing device trigger in IoT by cooperation of a network device and other devices according to one preferred embodiment of the present invention, rather than limiting the present invention. Other preferred embodiments, e.g., functional architecture employing other type of source devices, databases or target devices, or functional architecture only including one or more logics there among, are likewise applicable to the present invention and covered within the protection scope of the present invention.

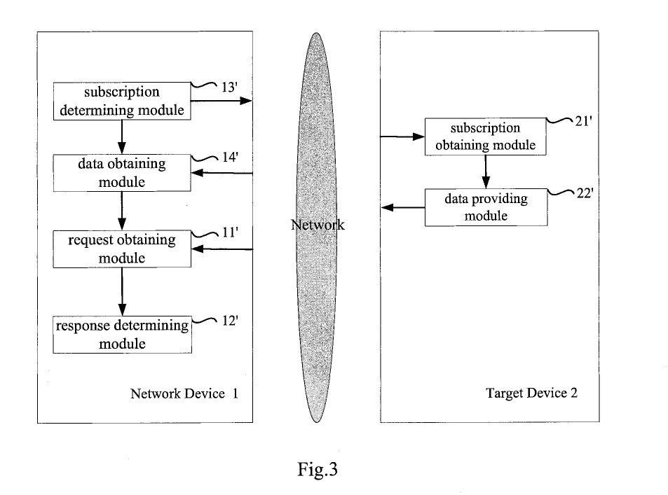

FIG. 3 shows a schematic diagram of a network device and a target device for device trigger in IoT according to one preferred embodiment of the present invention; wherein, the network device includes a request obtaining module 11′, a response determining module 12′, a subscription determining module 13′, a data obtaining module 14′; the target device includes a subscription obtaining module 21′, a data providing module 22′. Specifically, the subscription determining module 13′ of the network device determines a data subscription request corresponding to the target device; the subscription obtaining module 21′ of the target device obtains a data subscription request sent by a network device; the data providing module 22′ provides subscribed data corresponding to the data subscription request to the network device based on the data subscription request; accordingly, the data obtaining module 14′ of the network device obtains, based on the data subscription request, subscribed data corresponding to the target device; the request obtaining module 11′ obtains device trigger request(s) corresponding to one or more target devices; the response determining module 12′ determines, based on the device trigger request in conjunction with the subscribed data, a device trigger response corresponding to the device trigger request, wherein the subscribed data corresponds to the device trigger request. Herein, the request obtaining module 11′ and the response determining module 12′ are identical or substantially identical to corresponding modules shown in FIG. 2, which are thus not detailed here, but incorporated here by reference.

The above modules work constantly therebetween. Here, those skilled in the art should understand that “constantly” means the above various modules perform determining a data subscription request, obtaining a data subscription request, providing subscribed data, obtaining subscribed data, obtaining device trigger request(s), determining a device trigger response respectively in real-time or according a preset or real-time adjusted working pattern requirements, until the network device stops obtaining device trigger request(s) corresponding to one or more target devices.

The subscription determining module 13′ of the network device determines a data subscription request corresponding to the target device.

Specifically, the subscription determining module 13′ may voluntarily initiates a data subscription request to the target device based on a default configuration or other settings, and may also determine a data subscription request corresponding to the target device based on the device trigger request; the data subscription request includes target data requested for the target device.

Preferably, the subscription determining module 13′ may determine whether to perform relevant data subscription based on any of or a combination of the following two conditions: 1) change interval in the target device, i.e., update frequency of data in the target device; 2) trigger request frequency of the network device, wherein a threshold of the trigger request frequency may be a default setting of the network device or determined based on other conditions. For example, if the change interval of the target device is very long, i.e., the data update in the target device is not frequent, it is suitable for data subscription; if the device is frequently triggered, it means it is necessary to perform relevant data subscription. Here, when the device trigger function of the network device is not activated, it is likely that the network device has no relevant data therein, and only when the change interval and the request frequency corresponding to a pre-subscribed data exceeds a predetermined value, the network data will subscribe for the data from the target device application. The subscription of the data may be dynamically varied. If a data does not satisfy the subscription condition any longer, the network device may cancel subscription for the data and update in the database.

Preferably, the data subscription request includes a presence subscription request, i.e., subscribing for presence information (e.g., online, offline, busy, low battery, location, etc.) of the device to the target device through the presence subscription request. For example, if the response to the device trigger request needs to utilize the application data of the target device, then the data subscription request requests subscribing the application data; if the response to the device trigger request needs to utilize the presence information of the target device, then the data subscription request requests subscribing for presence information of the target device.

Preferably, the data subscription request includes identification information corresponding to the data subscription request. The identification information may be generated by the network device to indicate management indication information such as the type of the request, the type of the subscribed data, etc. For example, the MTC-IWF allocates a reference number to the data subscription request as the identification information to thereby replace SCS.

One preferred embodiment of the data subscription request is described below; the embodiment shows that whether a data should be subscribed if it's not subscribed before:

Step 1. Once a device trigger request is received, record the trigger request information, i.e. when it's received, what data is requested;

Step 2. Once its related trigger response is received, record the trigger response information, i.e. the value of the data, when it's received;

Step 3. Check if the average change interval of the saved data and the request frequency are beyond related pre-defined value, if the subscription criteria is met, send the subscribe request for this data if it's not subscribed. If a subscribed data cannot meet the criteria, data subscription logic should cancel the subscription dynamically. Trigger reference number for the subscription (i.e. identification information) will be stored in the data subscription logic to co-relate the publish message from the target device. Here, preferably, it may further determine the subscribe request for the data based on the change history/trend of one data or the status of the target device, etc. . . . .

Here, the data subscription request may be directly sent to the target device or sent to a relay device (e.g., SMS-SC/GMSC/WMSC, etc.), so as to obtain subscribed data corresponding to the subscription request from the relay device; the relay device may directly obtain subscribed data from the target device based on the data subscription request or determine subscribed data corresponding to the data subscription request based on the data obtained through other manner. For example, the relay device detects whether the trigger reference number (i.e., identification information) in the data subscription request is applied to data subscription; if so, reads the data released by the target device from for example a load field or update related data field in the database.

The subscription obtaining module 21′ of the target device obtains a data subscription request sent by a network device.

Specifically, the subscription obtaining module 21′ obtains the data subscription request through direct interaction with the network device, or obtains the data subscription request through interaction with other relay device (e.g., SMS-SC). Preferably, the data subscription request includes identification information to indicate the type of the request and the data as requested, etc.

The data providing module 22′ provides subscribed data corresponding to the data subscription request to the network device based on the data subscription request.

Specifically, the data providing module 22′ publishes a current value of the subscribed data based on the data subscription request; when the data corresponding to the data subscription request changes, the current value is updated based on the data subscription request. If the subscription is cancelled, stop updating the data. Here, the subscribed data may be provided in real-time based on the data subscription request or sent according to a predetermined send time. Preferably, the data providing module 22′ may include, in the subscribed data, identification information consistent with the data subscription request, so as to correspond to the data subscription request.

Accordingly, the data obtaining module 14′ of the network device obtains, based on the data subscription request, subscribed data corresponding to the target device.

Specifically, the data obtaining module 14′ obtains the subscribed data through direct interaction with the target device or interaction with other relay device providing the subscribed data. For example, if the data subscription request includes a presence subscription request, then the data obtaining module 14′ may obtain the presence information from the target device or from other network device (e.g., HSS) known the target device. Preferably, for a constrained device, the presence information may be simplified as “online/offline”; for a non-constrained device, the presence information may be more, e.g., location, busy, low battery, etc.

Preferably, the response determining module 12′ determines, based on the device trigger request in conjunction with subscribed data corresponding to the target device, a device trigger response corresponding to the device trigger request, wherein the device trigger response includes response time information.

Specifically, the response determining module 12′ may determine a device trigger response based on the time controlled logic shown in FIG. 2, wherein, the response time information includes settings regarding when to send the device trigger response. For example, if the time of the target device is 7:00 am-7:00 pm, then it is allowed to response normally to the trigger request; otherwise, the device trigger request is routed to a designated on-duty device, or if there is no designated on-duty device, the request is directly rejected. Here, the based time may be time information of the target device, time information of the network device, or time information for initiating a source request, etc.

Preferably, the response determining module 12′ determines, based on the device trigger request in conjunction with subscribed data corresponding to the target device, a device trigger response corresponding to the device trigger request, wherein the device trigger response includes identification information of a target processing device corresponding to the device trigger request.

Specifically, the response determining module 12′ may determine which device the device trigger request is routed for processing based on the routing logic as shown in FIG. 2, for example, if it is needed to route the device trigger request to its requesting device or other alternative devices for processing, then the device identification information of requesting device or other alternative devices will be included in the device trigger request as the identification information of a target processing device.

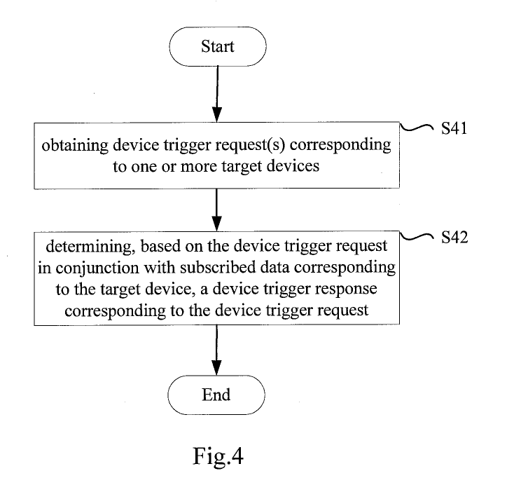

FIG. 4 shows a flow diagram of a method for device trigger in IoT by a network device according to another aspect of the present invention. Specifically, in the step S41, the network device obtains device trigger request(s) corresponding to one or more target devices; in the step S42, the network device determines, based on the device trigger request in conjunction with subscribed data corresponding to the target device, a device trigger response corresponding to the device trigger request

The above steps work constantly therebetween. Here, those skilled in the art should understand that “constantly” means the above various steps perform obtaining device trigger request(s), determining a device trigger response respectively in real-time or according a preset or real-time adjusted working pattern requirements, until the network device stops obtaining device trigger request(s) corresponding to one or more target devices.

In the step S41, the network device obtains device trigger request(s) corresponding to one or more target devices.

Specifically, in the step S41, the network device may obtain, through various kinds of relevant protocols, device trigger request(s) for one or more target devices from other device or application. Here, if the device trigger request corresponds to a single target device, then the device trigger request contains device identification information of the target device; if the device trigger request(s) corresponds to a plurality of target devices, then the device trigger request contains device identification information of a plurality of the target devices. Preferably, device trigger may be further applied to a device group, and then the device trigger request includes identification information of the group. A plurality of device addresses corresponding to the group identification information is obtained by for example MTC-IWF, SMS-SC or MME from the local database or centralized database (e.g., HSS).

In the step S42, the network device determines, based on the device trigger request in conjunction with subscribed data corresponding to the target device, a device trigger response corresponding to the device trigger request.

Specifically, in the step S42, the network device obtains the subscribed data by obtaining stored subscribed data corresponding to the target device from the local database, or obtains the subscribed data from the centralized database (e.g., HSS), wherein the subscribed data includes, but not limited to, the data corresponding to applications of the target device, presence information of the target device, various kinds of predetermined processing logic corresponding to the target device, and etc.; then, in the step S42, the network device detects, with reference to the subscribed data, the device trigger request to determine whether it should respond directly, reject to respond, or forward the trigger request to other device.

Herein, the device trigger response includes at least one of the following:
Responding the device trigger request, i.e., the network device responds directly based on the subscribed data on behalf of the target device; in the case of responding directly, the device trigger request will not be sent the corresponding target device. Preferably, to make it's transparent to the request originator; the network device may also generate the delivery report before sending real trigger response if needed.
Rejecting the device trigger request, for example, based on the subscribed data, when the target device is not available (e.g. offline, busy, low battery, or outside defined available time intervals, or it's not in the location that predefined, or other scenarios that matches the definition of target device unavailable . . . ), it will reject by sending normal Message Delivery Report (including such as cause code, trigger reference number, SCS Identifier) to the request originator.
Routing the device trigger request, i.e., routing the device trigger request to related device; for example, if the above 2 actions cannot be taken, the network device will determine to route the device trigger request to such as the target device requested or alternative device; for example, if the target device is not available (e.g. offline, busy, low battery, or outside defined available time intervals), or the target device has been presented, or the network device has received notification from the target device, then the trigger request will be forwarded to alternative device. Here, preferably, to make all this operations transparent to the target device or requested device, the target device may modify related parameters in the device trigger response, such as, modification the origination address of the device trigger response to the target device requested.

Preferably, in the step S42, the network device determines, based on the device trigger request in conjunction with subscribed data corresponding to the target device and related configuration strategy, a device trigger response corresponding to the device trigger request.

Specifically, the related configuration strategy includes, but not limited to, device trigger handling logic, time controlled logic, presence controlled logic, routing logic and data subscription logic and so on.

Here, once the network device receives a device trigger request, the device trigger handling logic will be started; specifically, the network device queries, from among the local or global database (e.g., HSS) a trigger request handling policy for the target device, and further, may also determines whether to call ancillary policies such as time controlled logic, presence controlled logic, and the like; if the trigger request should not be rejected, detects the data as requested by the trigger request have been subscribed or not; if so, directly responds to the source device with the subscribed data; if a route is needed, the routing logic will be called to perform routing.

The time controlled logic allows sending the device trigger request(s) to the target device only during defined time intervals and avoid unnecessary trigger delivery outside these defined time intervals. Specifically, the time controlled logic queries the time control policy from local or global database (e.g., HSS) for the target device; and takes action base on the policy and local time of the network device/target device.

The presence controlled logic allows customizing the trigger request handling base on the presence of the target device, e.g., online, offline, busy, low battery, location, etc. . . . . Specifically, the presence controlled logic queries the presence control policy from local or global database (e.g., HSS) for the target device; and takes action base on the policy and saved presence data of the target device. Herein, if presence controlled logic is enabled on the network device, presence information can be retrieved from the subscribed data, or alternatively, the presence information can also be retrieved by querying other network devices, like HSS, etc. . . . .

The routing logic will determine whether route the trigger request to target device it requested or other devices or not. Specifically, the routing logic queries the routing control policy from local or global database (e.g. HSS) for the target device, and applies the routing logic base on the policy. At least, one of below 2 routing will be taken:
Route to the required target device;
Route to alternative target device; this happens in the scenario of load balance, required target device unavailable, or other scenarios that matches the definition for alternative routing.

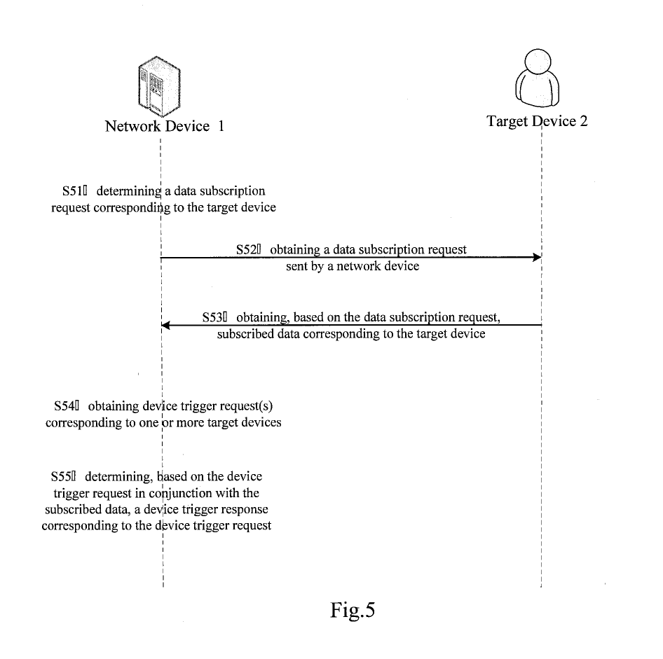

FIG. 5 shows a flow diagram of a method for device trigger in IoT by cooperation of a network device and a target device according to one preferred embodiment of the present invention. Specifically, in the step S51, the network device 1 determines a data subscription request corresponding to the target device; in the step S52, the target device 2 obtains a data subscription request sent by a network device; in the step S53, the target device 2 provides subscribed data corresponding to the data subscription request to the network device based on the data subscription request; accordingly, in the step S53, the network device 1 obtains, based on the data subscription request, subscribed data corresponding to the target device; in the step S54, the network device 1 obtains device trigger request(s) corresponding to one or more target devices; in the step S55, the network device 1 determines, based on the device trigger request in conjunction with the subscribed data, a device trigger response corresponding to the device trigger request, wherein the subscribed data corresponds to the device trigger request. Herein, the step S54 is identical or substantially identical to corresponding step S41 shown in FIG. 4, the step S55 is identical or substantially identical to corresponding step S42 shown in FIG. 4, which are thus not detailed here, but incorporated here by reference.

The above steps work constantly therebetween. Here, those skilled in the art should understand that “constantly” means the above various steps perform determining a data subscription request, obtaining a data subscription request, providing subscribed data, obtaining subscribed data, obtaining device trigger request(s), determining a device trigger response respectively in real-time or according a preset or real-time adjusted working pattern requirements, until the network device stops obtaining device trigger request(s) corresponding to one or more target devices.

In the step S51, the network device 1 determines a data subscription request corresponding to the target device.

Specifically, in the step S51, the network device 1 may voluntarily initiates a data subscription request to the target device based on a default configuration or other settings, and may also determine a data subscription request corresponding to the target device based on the device trigger request; the data subscription request includes target data requested for the target device.

Preferably, in the step S51, the network device 1 may determine whether to perform relevant data subscription based on any of or a combination of the following two conditions: 1) change interval in the target device, i.e., update frequency of data in the target device; 2) trigger request frequency of the network device, wherein a threshold of the trigger request frequency may be a default setting of the network device or determined based on other conditions. For example, if the change interval of the target device is very long, i.e., the data update in the target device is not frequent, it is suitable for data subscription; if the device is frequently triggered, it means it is necessary to perform relevant data subscription. Here, when the device trigger function of the network device is not activated, it is likely that the network device has no relevant data therein, and only when the change interval and the request frequency corresponding to a pre-subscribed data exceeds a predetermined value, the network data will subscribe for the data from the target device application. The subscription of the data may be dynamically varied. If a data does not satisfy the subscription condition any longer, the network device may cancel subscription for the data and update in the database.

Preferably, the data subscription request includes a presence subscription request, i.e., subscribing for presence information (e.g., online, offline, busy, low battery, location, etc.) of the device to the target device through the presence subscription request. For example, if the response to the device trigger request needs to utilize the application data of the target device, then the data subscription request requests subscribing the application data; if the response to the device trigger request needs to utilize the presence information of the target device, then the data subscription request requests subscribing for presence information of the target device.

Preferably, the data subscription request includes identification information corresponding to the data subscription request. The identification information may be generated by the network device to indicate management indication information such as the type of the request, the type of the subscribed data, etc. For example, the MTC-IWF allocates a reference number to the data subscription request as the identification information to thereby replace SCS.

One preferred embodiment of the data subscription request is described below; the embodiment shows that whether a data should be subscribed if it's not subscribed before:

Step 1. Once a device trigger request is received, record the trigger request information, i.e. when it's received, what data is requested;

Step 2. Once its related trigger response is received, record the trigger response information, i.e. the value of the data, when it's received;

Step 3. Check if the average change interval of the saved data and the request frequency are beyond related pre-defined value, if the subscription criteria is met, send the subscribe request for this data if it's not subscribed. If a subscribed data cannot meet the criteria, data subscription logic should cancel the subscription dynamically. Trigger reference number for the subscription (i.e. identification information) will be stored in the data subscription logic to co-relate the publish message from the target device. Here, preferably, it may further determine the subscribe request for the data based on the change history/trend of one data or the status of the target device, etc. . . . .

Here, the data subscription request may be directly sent to the target device or sent to a relay device (e.g., SMS-SC/GMSC/WMSC, etc.), so as to obtain subscribed data corresponding to the subscription request from the relay device; the relay device may directly obtain subscribed data from the target device based on the data subscription request or determine subscribed data corresponding to the data subscription request based on the data obtained through other manner. For example, the relay device detects whether the trigger reference number (i.e., identification information) in the data subscription request is applied to data subscription; if so, reads the data released by the target device from for example a load field or update related data field in the database.

In the step S52, the target device 2 obtains a data subscription request sent by a network device.

Specifically, in the step S52, the target device 2 obtains the data subscription request through direct interaction with the network device, or obtains the data subscription request through interaction with other relay device (e.g., SMS-SC). Preferably, the data subscription request includes identification information to indicate the type of the request and the data as requested, etc.

In the step S53, the target device 2 provides subscribed data corresponding to the data subscription request to the network device based on the data subscription request.

Specifically, in the step S53, the target device 2 publishes a current value of the subscribed data based on the data subscription request; when the data corresponding to the data subscription request changes, the current value is updated based on the data subscription request. If the subscription is cancelled, stop updating the data. Here, the subscribed data may be provided in real-time based on the data subscription request or sent according to a predetermined send time. Preferably, in the step S53, the target device 2 may include, in the subscribed data, identification information consistent with the data subscription request, so as to correspond to the data subscription request.

Accordingly, in the step S53, the network device 1 obtains, based on the data subscription request, subscribed data corresponding to the target device.

Specifically, in the step S53, the network device 1 obtains the subscribed data through direct interaction with the target device or interaction with other relay device providing the subscribed data. For example, if the data subscription request includes a presence subscription request, then in the step S53, the network device 1 may obtain the presence information from the target device or from other network device (e.g., HSS) known the target device. Preferably, for a constrained device, the presence information may be simplified as “online/offline”; for a non-constrained device, the presence information may be more, e.g., location, busy, low battery, etc.

Preferably, in the step S55, the network device 1 determines, based on the device trigger request in conjunction with subscribed data corresponding to the target device, a device trigger response corresponding to the device trigger request, wherein the device trigger response includes response time information.

Specifically, in the step S55, the network device 1 may determine a device trigger response based on the time controlled logic shown in FIG. 4, wherein, the response time information includes settings regarding when to send the device trigger response. For example, if the time of the target device is 7:00 am-7:00 pm, then it is allowed to response normally to the trigger request; otherwise, the device trigger request is routed to a designated on-duty device, or if there is no designated on-duty device, the request is directly rejected. Here, the based time may be time information of the target device, time information of the network device, or time information for initiating a source request, etc.

Preferably, in the step S53, the network device 1 determines, based on the device trigger request in conjunction with subscribed data corresponding to the target device, a device trigger response corresponding to the device trigger request, wherein the device trigger response includes identification information of a target processing device corresponding to the device trigger request.

Specifically, in the step S53, the network device 1 may determine which device the device trigger request is routed for processing based on the routing logic as shown in FIG. 4, for example, if it is needed to route the device trigger request to its requesting device or other alternative devices for processing, then the device identification information of requesting device or other alternative devices will be included in the device trigger request as the identification information of a target processing device.

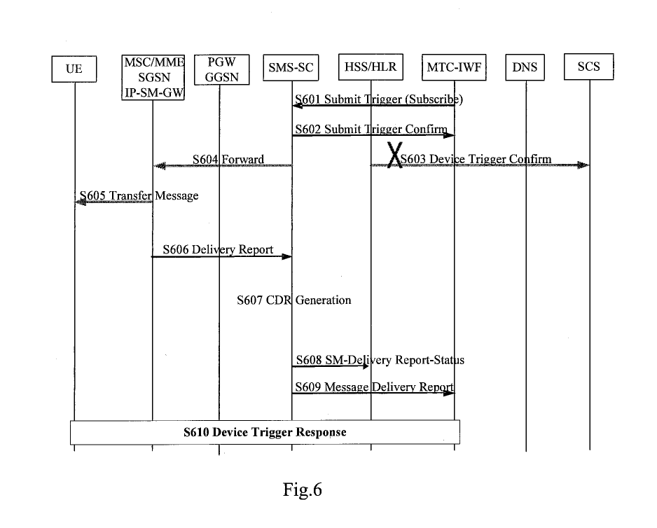

FIG. 6 shows a data subscription flow diagram improved based on the 3GPP TS29.36 Specification according to a preferred embodiment of the present invention; this flow is executed at the MTC interface.

Specifically, in the 5601, the data subscription information will be carried on a normally submitted trigger request load; different from the existing trigger request defined in 3GPP TS29.36, the reference number with a special management indication will be allocated by the MTC-IWF so as to replace the reference number allocated by SCS in a common trigger request; in the S610, a device trigger response mechanism defined in the present invention is performed, i.e., in order to respond to the received device trigger request (including data subscription), when data changes, the UE will release the subscribed data till the subscription is cancelled or changed. The MTC-IWF will store the data so as to be available for subsequent trigger request processing. Besides, step S603 defined in 3GPP TS29.36 will be deleted. Other steps are performed based on what are defined in 3GPP TS 29.36, which will not be detailed here but are incorporated here by reference.

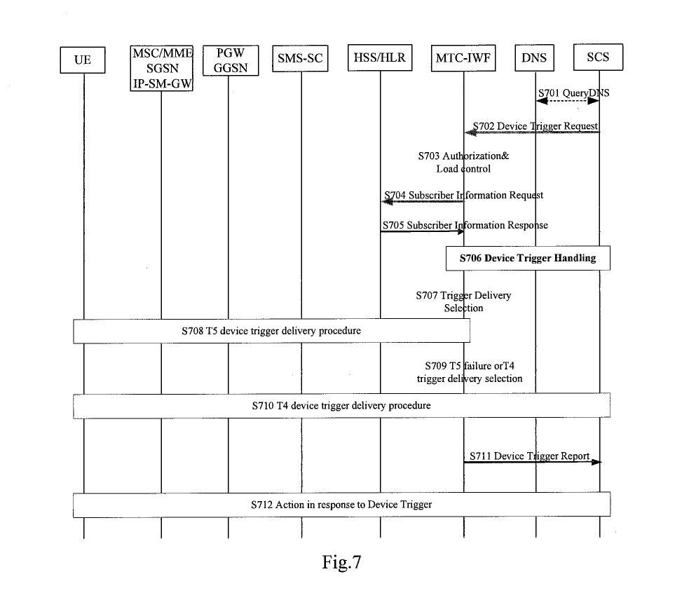

FIG. 7 shows a flow diagram of device trigger in IoT improved based on 3GPP TS23.682 Specification according to one preferred embodiment of the present invention.

Specifically, in the step S706, the device trigger response mechanism as defined in FIG. 4 or FIG. 5 according to the present invention is performed, and the details of other steps are defined in section 5.2 of 3GPP TS23.682, which will not be detailed here but are incorporated here by reference.

To those skilled in the art, apparently the present invention is not limited to the details of the aforementioned exemplary embodiments; moreover, under the premise of not deviating from the spirit or fundamental characteristics of the invention, this invention can be accomplished in other specific forms. Therefore, the embodiments should be considered exemplary and non-restrictive no matter from which point, the scope of the invention is defined by the appended claims instead of the above description, and aims at covering the meanings of the equivalent components falling into the claims and all changes within the scope in this invention. Any reference sign in the claims shall not be deemed as limiting the concerned claims. Besides, apparently the word “comprise/include” does not exclude other components or steps, singular numbers does not exclude complex numbers, the plurality of components or means mentioned in device claims may also be accomplished by one component or means through software or hardware, the wording like first and second are only used to represent names rather than any specific order.

List of abbreviations in the description and drawings:

| | |
|---|---|
| AS | Application Server |
| CDF | Charging Data Function |
| CGF | Charging Gateway Function |
| DNS | Domain Name System |
| GGSN | Gateway GPRS Support Node |
| GPRS | General Packet Radio Service |
| HLR | Home Location Register |
| HSS | Home Subscriber Server |
| HPLMN | Home Public Land Mobile Network |
| IP-SM-GW | Internet Protocol Short Message GateWay |
| IoT | Internet of things |
| M2M | Machine-to-Machine communications |
| MME | Mobility Management Entity |
| MSC | Mobile Switch Center |
| MTC | Machine-Type Communications |
| MTC-AAA | MTC-Authentication, Authorization, Accounting |
| MTC-IWF | MTC-Inter Working Function |
| P-GW | Packet Data Network Gateway |
| RAN | Radio Access Network |
| SCS | Services Capability Server |
| SGSN | Serving GPRS Support Node |
| S-GW | Service Gateway |
| SME | Short Message Entity |
| SMS | Short Message Service |
| SMS-SC | SMS-Service Center |
| SMS-GMSC | SMS-Gateway Mobile Switching Center |
| SMS-IWMSC | SMS-InterWork Mobile Switch Center |
| VPLMN | Visited Public Land Mobile Network |
| UE | User Equipment |

1. A method for device trigger in IoT by a network device, wherein the method comprises:
obtaining device trigger request(s) corresponding to one or more target devices;
determining, based on the device trigger request in conjunction with subscribed data corresponding to the target device, a device trigger response corresponding to the device trigger request.

2. The method according to claim 1, wherein the method further comprises:
determining a data subscription request corresponding to the target device;
obtaining, based on the data subscription request, subscribed data corresponding to the target device;
wherein the determining, based on the device trigger request comprises:
determining, based on the device trigger request in conjunction with the subscribed data, a device trigger response corresponding to the device trigger request, wherein the subscribed data corresponds to the device trigger request.

3. The method according to claim 2, wherein the determining a data subscription request corresponding to the target device comprises:
determining a data subscription request corresponding to the user equipment, wherein the data subscription request includes identification information corresponding to the data subscription request.

4. The method according to claim 2, wherein the determining a data subscription request corresponding to the target device comprises:
determining a data subscription request corresponding to the user equipment, wherein the data subscription request includes a presence subscription request.

5. The method according to claim 1, wherein the determining, based on the device trigger request comprises:
determining, based on the device trigger request in conjunction with subscribed data corresponding to the target device, a device trigger response corresponding to the device trigger request, wherein the device trigger response includes response time information.

6. The method according to claim 1, wherein the determining, based on the device trigger request comprises:
determining, based on the device trigger request in conjunction with subscribed data corresponding to the target device, a device trigger response corresponding to the device trigger request, wherein the device trigger response includes identification information of a target processing device corresponding to the device trigger request.

7. A method for device trigger in IoT subsidiarily by a target device, wherein the method comprises:
obtaining a data subscription request sent by a network device;
providing subscribed data corresponding to the data subscription request to the network device based on the data subscription request.

8. A network device for device trigger in IoT, wherein the device comprises:
request obtaining module configured to obtain device trigger request(s) corresponding to one or more target devices;
response determining module configured to determine, based on the device trigger request in conjunction with subscribed data corresponding to the target device, a device trigger response corresponding to the device trigger request.

9. The network device according to claim 8, wherein the device further comprises:
subscription determining module configured to determine a data subscription request corresponding to the target device;
data obtaining module configured to obtain, based on the data subscription request, subscribed data corresponding to the target device;
wherein the response determining module is configured to:
determine, based on the device trigger request in conjunction with the subscribed data, a device trigger response corresponding to the device trigger request, wherein the subscribed data corresponds to the device trigger request.

10. The network device according to claim 9, wherein the subscription determining module is configured to:
determine a data subscription request corresponding to the user equipment, wherein the data subscription request includes identification information corresponding to the data subscription request.

11. The network device according to claim 9, wherein the subscription determining module is configured to:
determine a data subscription request corresponding to the user equipment, wherein the data subscription request includes a presence subscription request.

12. The network device according to claim 8, wherein the response determining module is configured to:
determine, based on the device trigger request in conjunction with subscribed data corresponding to the target device, a device trigger response corresponding to the device trigger request, wherein the device trigger response includes response time information.

13. The network device according to claim 8, wherein the response determining module is configured to:
determine, based on the device trigger request in conjunction with subscribed data corresponding to the target device, a device trigger response corresponding to the device trigger request, wherein the device trigger response includes identification information of a target processing device corresponding to the device trigger request.

14. A target device for device trigger in IoT subsidiarily, wherein the device comprises:
subscription obtaining module configured to obtain a data subscription request sent by a network device; and,
data providing module configured to provide subscribed data corresponding to the data subscription request to the network device based on the data subscription request.

15. A system for device trigger in IoT, wherein the system comprises the network device according to claim 8, and the target device comprises a subscription obtaining module configured to obtain a data subscription request sent by a network device and data providing module configured to provide subscribed data corresponding to the data subscription request to the network device based on the data subscription request.
